(19) United States
(12) Patent Application Publication
(10) Pub. No.: US 2014/0152563 A1
(43) Pub. Date: Jun. 5, 2014

(54) APPARATUS OPERATION DEVICE AND COMPUTER PROGRAM PRODUCT

(71) Applicant: Kabushiki Kaisha Toshiba, Tokyo (JP)

(72) Inventors: Kazushige OUCHI, Saitama-shi (JP); Hirokazu NAGATA, Ota-ku (JP); Hideki IBI, Ota-ku (JP); Kazuhide SAWA, Akishima-shi (JP)

(73) Assignee: Kabushiki Kaisha Toshiba, Tokyo (JP)

(21) Appl. No.: 13/975,971

(22) Filed: Aug. 26, 2013

Related U.S. Application Data
(63) Continuation of application No. PCT/JP2013/069571, filed on Jul. 11, 2013.

(30) Foreign Application Priority Data
Nov. 30, 2012 (JP) 2012-263230

(51) Int. Cl. G06F 3/0346

(52) U.S. Cl. CPC G06F 3/0346
USPC 345/158

(57) ABSTRACT

According to one embodiment, an apparatus operation device includes: a direction operation module configured to receive an operating instruction in a two-dimensional direction; a recognizing module configured to recognize a swing motion or a tilting motion of the apparatus operation device; and an output module configured to output a first operation command corresponding to a first operation for screen transition corresponding to a predetermined condition when the swing motion or the tilting motion recognized satisfies the predetermined condition, and to output a second operation command corresponding to a second operation for transition of a pointer on the screen in the two-dimensional direction when the operating instruction in the two-dimensional direction is received.

### CROSS-REFERENCE TO RELATED APPLICATIONS

This application is a continuation of PCT international application Ser. No. PCT/JP2013/069571, filed on Jul. 11, 2013, which designates the United States, incorporated herein by reference, and which is based upon and claims the benefit of priority from Japanese Patent Application No. 2012-263230, filed on Nov. 30, 2012, the entire contents of which are incorporated herein by reference.

### FIELD

Embodiments described herein relate generally to an apparatus operation device and a computer program product.

### BACKGROUND

Some conventional information processing apparatuses such as personal computers (PC) and television receivers detect motion of an apparatus operation device such as a remote controller, and move a pointer (cursor) on a screen along with the motion of the apparatus operation device.

When selecting a desired item of content out of a plurality of items of the content on the screen (for example, applications for the PC and broadcast programs for the television receiver), the above-described conventional technology, however, may not allow a user to easily select the desired item of the content. For example, when the content is displayed over a plurality of display pages, the user may not be able to perform an operation to turn pages to select the content intuitively because the above-described technology is to move the pointer within a display page.

In view of the situation above, the present invention aims to provide an apparatus operation device and a computer program that allow operability of the user to be improved.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram for explaining an appearance of an apparatus operation device and a use situation of the device according to a first embodiment;

FIG. 2 is an exemplary schematic diagram for explaining recognition of a tilting motion of the apparatus operation device in the first embodiment;

FIG. 3 is an exemplary block diagram schematically illustrating a configuration of a control system of the apparatus operation device in the first embodiment;

FIG. 4 is an exemplary block diagram illustrating a functional configuration of the apparatus operation device in the first embodiment;

FIG. 5 is an exemplary flowchart illustrating an example of operation of the apparatus operation device in the first embodiment;

FIG. 6 is an exemplary flowchart illustrating an example of a process to recognize a swing motion in the first embodiment;

FIG. 7 is an exemplary chart illustrating an example of changes of acceleration in a swing motion in a leftward direction in the first embodiment;

FIG. 8 is an exemplary chart illustrating an example of changes of acceleration in a swing motion in a rightward direction in the first embodiment;

FIG. 9 is an exemplary chart illustrating an example of changes of acceleration in a swing motion in a downward direction in the first embodiment;

FIG. 10 is an exemplary chart illustrating an example of changes of acceleration in a swing motion in an upward direction in the first embodiment;

FIG. 11 is an exemplary schematic diagram for explaining an example of a screen in the first embodiment;

FIG. 12 is an exemplary schematic diagram for explaining an example of changes of the screen in the first embodiment;

FIG. 13 is an exemplary schematic diagram for explaining an example of changes of the screen in the first embodiment;

FIG. 14 is an exemplary block diagram illustrating a functional configuration of an apparatus operation device according to a second embodiment;

FIG. 15 is an exemplary flowchart illustrating an example of operation of the apparatus operation device in the second embodiment;

FIG. 16 is an exemplary flowchart illustrating an example of operation of an apparatus operation device according to a third embodiment; and

FIG. 17 is an exemplary flowchart illustrating an example of a process to detect a swing motion in the third embodiment.

### DETAILED DESCRIPTION

In general, according to one embodiment, an apparatus operation device comprises: a direction operation module configured to receive an operating instruction in a two-dimensional direction; a recognizing module configured to recognize a swing motion or a tilting motion of the apparatus operation device; and an output module configured to output a first operation command corresponding to a first operation for screen transition corresponding to a predetermined condition when the swing motion or the tilting motion recognized satisfies the predetermined condition, and to output a second operation command corresponding to a second operation for transition of a pointer on the screen in the two-dimensional direction when the operating instruction in the two-dimensional direction is received.

With reference to the accompanying drawings, exemplary embodiments of an apparatus operation device and a computer program will be described in detail hereinafter. In the respective embodiments, common constituents bear the same reference numerals or signs, and the redundant explanations thereof are omitted.

### First Embodiment

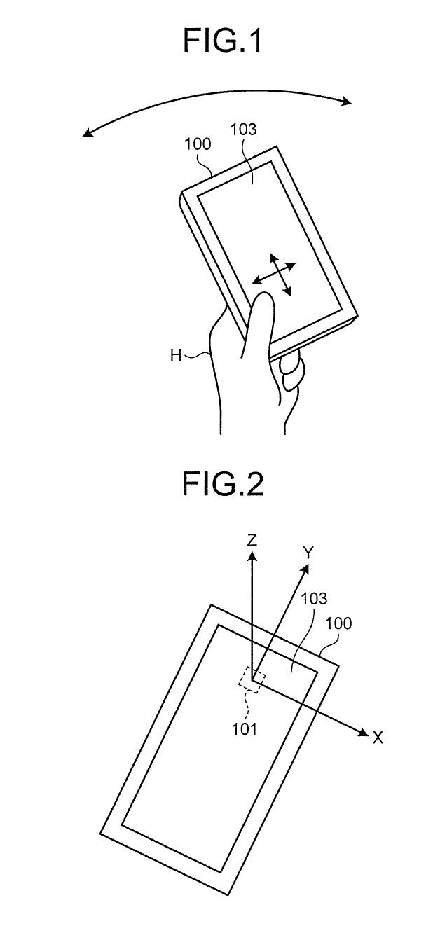

FIG. 1 is a schematic diagram for explaining an appearance of an apparatus operation device 100 and a use situation of the device according to a first embodiment. FIG. 2 is a schematic diagram for explaining recognition of a tilting motion of the apparatus operation device 100 in the first embodiment.

As illustrated in FIG. 1, the apparatus operation device 100 is a device that a user holds in his/her hand H to give operating instructions, and other than a remote controller for a television receiver (hereinafter, referred to as a television), the apparatus operation device 100 may be a hand-held terminal such as a cellular phone that is installed with an application program to operate a television, a personal computer (PC), and the like. In the first embodiment, a remote controller for a television is illustrated and described as one example.

The apparatus operation device 100 comprises a touch pad 103 that receives operating instructions in a two-dimensional direction by the hand H by detecting a position of touch with a finger of the hand H based on changes in electrostatic capacitance and such. Meanwhile, a cursor key, a trackball, or the like may be configured to receive the operating instructions in the two-dimensional direction by the hand H.

As illustrated in FIG. 2, the apparatus operation device 100 comprises a motion input module 101 that receives motion input, such as an acceleration sensor and a gyro sensor, by a swing motion or a tilting motion of the apparatus operation device in X, Y, and Z directions. In the first embodiment, an acceleration sensor that detects the acceleration of the apparatus operation device in the X, Y, and Z directions is used as the motion input module 101. However, the motion input module 101 may be not the acceleration sensor but other motion detection sensors, such as an angular velocity sensor, as long as such sensors are capable of detecting the motion of the body of the apparatus operation device 100.

The apparatus operation device 100 transmits (outputs) a pointing command, which makes a pointer (cursor) on a screen change in a direction of an operating instruction, to a television when the apparatus operation device 100 receives the operating instruction in the two-dimensional direction by the touch pad 103. The apparatus operation device 100 further recognizes a swing motion or a tilt of the apparatus operation device by the motion input module 101, and when a large swing motion, for example, from side to side or up and down is made, the apparatus operation device 100 transmits (outputs) a scroll command that makes the screen change (scroll of a display page, turning pages, or a change of reproduction speed of content in reproduction) to the television corresponding to the swung direction. As a consequence, the user can intuitively operate the device appropriately using the change of the pointer on the screen and the change of the screen.

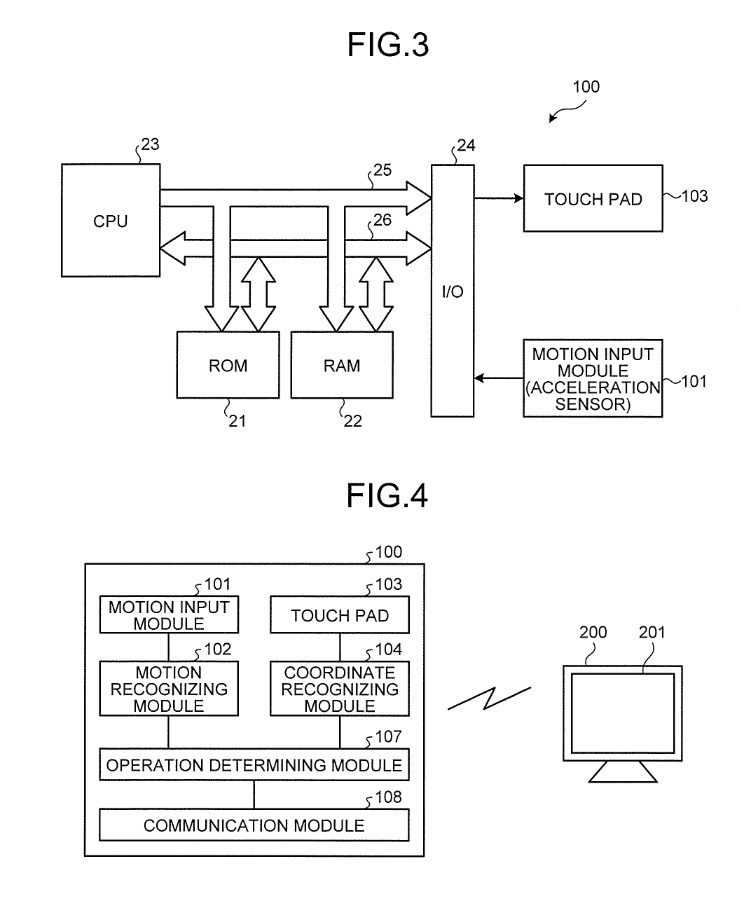

FIG. 3 is a block diagram schematically illustrating the configuration of a control system of the apparatus operation device 100 in the first embodiment. As illustrated in FIG. 3, the control system of the apparatus operation device 100 comprises a central processing unit (CPU) 23 that constitutes a microcomputer together with a read only memory (ROM) 21 and a random access memory (RAM) 22. The CPU 23 serves to control the whole apparatus operation device 100 in accordance with a control program stored in the ROM 21. The RAM 22 is used as a work area to temporarily store therein data necessary for performing various processes. The ROM 21 further stores therein various other programs including a computer program to control a target device of operation (for example, a display device 200 (see FIG. 4) such as a television receiver) by transmitting commands.

Furthermore, other input and output devices necessary to control the apparatus operation device 100 such as the touch pad 103 and the motion input module 101 are connected to the CPU via an I/O 24. The CPU 23, the ROM 21, the RAM 22, and the I/O 24 are connected via an address bus 25 for specifying addresses and a data bus 26 for inputting and outputting data.

Next, described will be the functional configuration that the CPU 23 of the apparatus operation device 100 realizes by executing various arithmetic processes in accordance with the program stored in the ROM 21. FIG. 4 is a block diagram illustrating the functional configuration of the apparatus operation device 100 in the first embodiment.

The apparatus operation device 100 comprises a motion recognizing module 102, a coordinate recognizing module 104, an operation determining module 107, and a communication module 108, as the functional configuration to output a scroll command to the display device 200 when a swing motion or a tilt of the apparatus operation device is recognized by the motion input module 101 or a pointing command when an operating instruction in a two-dimensional direction is received by the touch pad 103.

The motion recognizing module 102 recognizes a swing motion or a tilt of the apparatus operation device 100 in the X, Y, and Z directions from waveforms of the acceleration sensor as the motion input module 101. More specifically, for a swing motion, the motion recognizing module 102 sets up a threshold X1 (for example, 1.5G) of the acceleration in the X direction (positive direction), a threshold X2 (for example, −1.5G) of the acceleration in the X direction (negative direction), a threshold Y1 (for example, 1.5G) of the acceleration in the Y direction (positive direction), a threshold Y2 (for example, −1.5G) of the acceleration in the Y direction (negative direction), a threshold Z1 (for example, 1.5G) of the acceleration in the Z direction (positive direction), and a threshold Z2 (for example, −1.5G) of the acceleration in the Z direction (negative direction), and based on the timings of the acceleration in the respective directions crossing these thresholds, recognizes a swing motion in the X, Y, or Z direction (for example, up-down or left-right direction). As for the method to recognize a swing motion from tilting of the apparatus operation device, the method to use the above-described thresholds is merely an example, and other recognition methods such as DP matching and a method to learn feature quantity in advance may be used. The motion recognizing module 102 then outputs the result of recognition to the operation determining module 107.

The coordinate recognizing module 104 recognizes coordinates at which a touch operation is performed on the touch pad 103. Consequently, based on time-oriented changes of the coordinates at which the touch operation is performed, the coordinate recognizing module 104 recognizes an operating instruction in a two-dimensional direction. The coordinate recognizing module 104 then outputs the result of recognition to the operation determining module 107.

When a swing motion or a tilting motion recognized by the motion recognizing module 102 satisfies a predetermined condition (for example, rightward swing, leftward swing, upward swing, or downward swing), the operation determining module 107 determines the motion as a scroll operation (first operation) that makes the screen change corresponding to the condition. Furthermore, when the operation determining module 107 receives an operating instruction in a two-dimensional direction based on the recognition result of the coordinate recognizing module 104, the operation determining module 107 determines the operating instruction as a pointer operation (second operation) that changes the pointer on the screen in the two-dimensional direction.

The communication module 108 is communication means such as infrared, Bluetooth (registered trademark), and a wireless local area network (LAN) to transmit commands to the display device 200. Based on a scroll operation or a pointer operation determined by the operation determining module 107, the communication module 108 posts (outputs) an operation command corresponding to the operation to the display device 200 via an infrared communication or a wireless communication. More specifically, the communication module 108 posts a scroll command to the display device 200 for a scroll operation, and posts a pointing command for a pointer operation. The display device 200 then controls the display on a display surface 201 based on the scroll command or the pointing command posted.

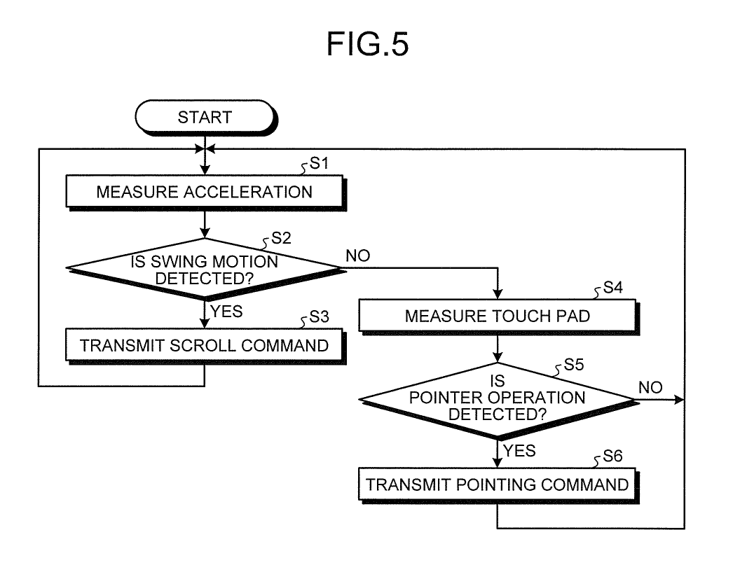

Next, the process to transmit a scroll command and a pointing command will be described more specifically. FIG. 5 is a flowchart illustrating an example of operation of the apparatus operation device 100 in the first embodiment.

As illustrated in FIG. 5, once the process is started, the motion input module 101 measures the acceleration of the apparatus operation device (S1). The operation determining module 107 then determines whether the motion recognizing module 102 detected (recognized) a predetermined swing motion or tilting motion based on the acceleration measured by the motion input module 101 (S2).

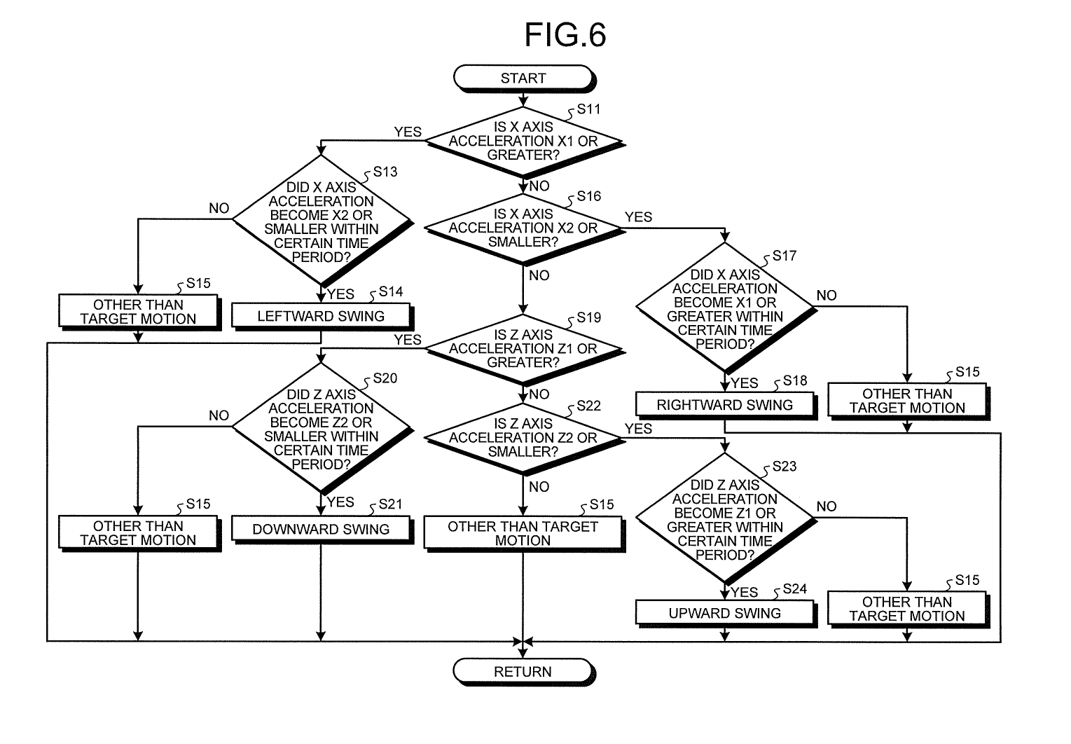

Now, the process of the motion recognizing module 102 to recognize a swing motion will be described in detail. FIG. 6 is a flowchart illustrating an example of the process to recognize a swing motion in the first embodiment.

As illustrated in FIG. 6, once the process to recognize a swing motion is started, the motion recognizing module 102 determines whether the X axis (X direction) acceleration is equal to or greater than the threshold X1 (S11). When the acceleration is equal to or greater than the threshold X1 (Yes at S11), it means that the device is swung in the positive direction of the X axis (leftward direction), and thus the motion recognizing module 102 determines whether the X axis acceleration becomes equal to or smaller than the threshold X2 within a certain time period (S13). When the acceleration is equal to or smaller than the threshold X2 within the certain time period (Yes at S13), it means that the device is swung back in the negative direction of the X axis, and thus the motion recognizing module 102 recognizes that a one-time leftward swing motion is made (S14).

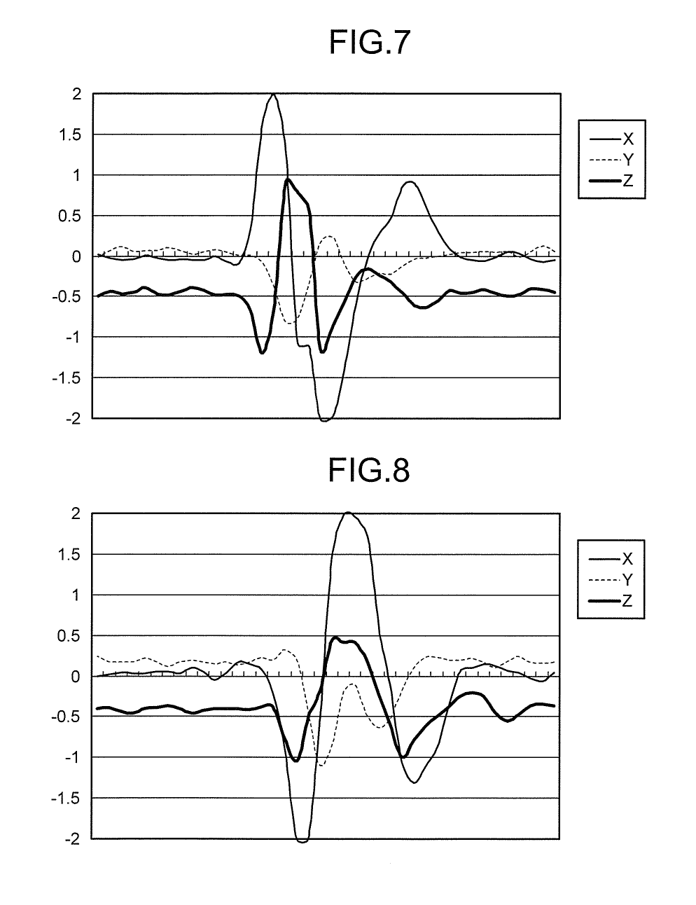

FIG. 7 is a chart illustrating an example of changes of acceleration in a swing motion in a leftward direction. As illustrated in FIG. 7, when a leftward swing motion is made, a change of acceleration that turns from positive to negative appears in the X axis direction.

When the X axis acceleration is not equal to or smaller than the threshold X2 within the certain time period (No at S13), it means that the device is merely tilted in the left direction and a leftward swing motion is not made, and thus the motion recognizing module 102 recognizes that a motion other than the target motion is made (S15).

When the X axis acceleration is not equal to or greater than the threshold X1 (No at S11), the motion recognizing module 102 determines whether the X axis acceleration is equal to or smaller than the threshold X2 (S16). When the acceleration is equal to or smaller than the threshold X2 (Yes at S16), it means that the device is swung in the negative direction of the X axis (rightward direction), and thus the motion recognizing module 102 determines whether the X axis acceleration becomes equal to or greater than the threshold X1 within a certain time period (S17). When the acceleration is equal to or greater than the threshold X1 within the certain time period (Yes at S17), it means that the device is swung back in the positive direction of the X axis, and thus the motion recognizing module 102 recognizes that a one-time rightward swing motion is made (S18).

FIG. 8 is a chart illustrating an example of changes of acceleration in a swing motion in a rightward direction. As illustrated in FIG. 8, when a rightward swing motion is made, a change of acceleration that turns from negative to positive appears in the X axis direction.

When the X axis acceleration is not equal to or greater than the threshold X1 within the certain time period (No at S17), it means that the device is merely tilted in the right direction and a rightward swing motion is not made, and thus the motion recognizing module 102 recognizes that a motion other than the target motion is made (S15).

When the X axis acceleration is not equal to or smaller than the threshold X2 (No at S16), the motion recognizing module 102 determines whether Z axis (Z direction) acceleration is equal to or greater than the threshold Z1 (S19). When the acceleration is equal to or greater than the threshold Z1 (Yes at S19), it means that the device is swung in the positive direction of the Z axis (downward direction), and thus the motion recognizing module 102 determines whether the Z axis acceleration becomes equal to or smaller than the threshold Z2 within a certain time period (S20). When the acceleration is equal to or smaller than the threshold Z2 within the certain time period (Yes at S20), it means that the device is swung back in the negative direction of the Z axis, and thus the motion recognizing module 102 recognizes that a one-time downward swing motion is made (S21).

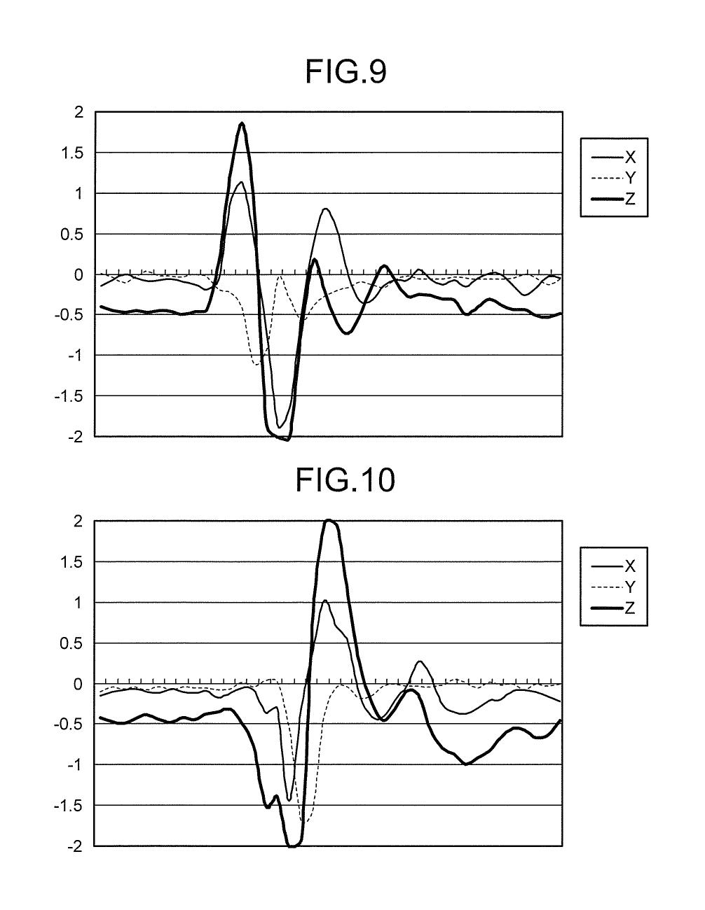

FIG. 9 is a chart illustrating an example of changes of acceleration in a swing motion in a downward direction. As illustrated in FIG. 9, when a downward swing motion is made, a change of acceleration that turns from positive to negative appears in the Z axis direction.

When the Z axis acceleration is not equal to or smaller than the threshold Z2 within the certain time period (No at S20), it means that the device is merely tilted downward and a downward swing motion is not made, and thus the motion recognizing module 102 recognizes that a motion other than the target motion is made (S15).

When the Z axis acceleration is not equal to or greater than the threshold Z1 (No at S19), the motion recognizing module 102 determines whether the Z axis acceleration is equal to or smaller than the threshold Z2 (S22). When the acceleration is equal to or smaller than the threshold Z2 (Yes at S22), it means that the device is swung in the negative direction of the Z axis (upward direction), and thus the motion recognizing module 102 determines whether the Z axis acceleration becomes equal to or greater than the threshold Z1 within a certain time period (S23). When the acceleration is equal to or greater than the threshold Z1 within the certain time period (Yes at S23), it means that the device is swung back in the positive direction of the Z axis, and thus the motion recognizing module 102 recognizes that a one-time upward swing motion is made (S24).

FIG. 10 is a chart illustrating an example of changes of acceleration in a swing motion in an upward direction. As illustrated in FIG. 10, when an upward swing motion is made, a change of acceleration that turns from negative to positive appears in the Z axis direction.

When the Z axis acceleration is not equal to or greater than the threshold Z1 within the certain time period (No at S23), it means that the device is merely tilted upward and an upward swing motion is not made, and thus the motion recognizing module 102 recognizes that a motion other than the target motion is made (S15).

When the Z axis acceleration is not equal to or smaller than the threshold Z2 (No at S22), it means that the device is not tilted in any directions, and thus the motion recognizing module 102 recognizes that a motion other than the target motion is made (S15). The foregoing process allows the motion recognizing module 102 to recognize swing motions in the up-down and left-right directions.

Referring back to FIG. 5, when a swing motion in the up-down or left-right direction is recognized (Yes at S2), the operation determining module 107 transmits a scroll command corresponding to the swing motion in the up-down or left-right direction recognized to the display device 200 via the communication module 108 (S3). More specifically, a left scroll command is transmitted to the display device 200 when a leftward swing motion is recognized. Likewise, a right scroll command is transmitted when a rightward swing motion is recognized, a down-left scroll command is transmitted when a downward swing motion is recognized, and an up scroll command is transmitted when an upward swing motion is recognized.

The scroll commands transmitted to the display device 200 may include an amount of scroll corresponding to a degree of swing motion in the up-down or left-right direction. The degree of swing motion includes magnitude of acceleration when the device is swung in the up-down or left-right direction (degree of tilt) and a length of time until the device is swung back. More specifically, when a swing motion is large (for example, when the magnitude of acceleration is large or the time until the device is swung back is short), a scroll command that makes the amount of scroll large is posted. Consequently, this allows the user to perform the scroll operation more intuitively.

When a swing motion in the up-down or left-right direction is not recognized (No at S2), the touch pad 103 measures a pointer operation on the touch pad thereof (S4). The operation determining module 107 then determines whether a pointer operation is detected based on the measurement of the touch pad 103 (S5). When no pointer operation is detected (No at S5), the operation determining module 107 returns to the process at S1. When a pointer operation is detected (Yes at S5), the operation determining module 107 transmits a pointing command corresponding to the pointer operation to the display device 200 via the communication module 108 (S6). More specifically, a left pointing command is transmitted to the display device 200 when a leftward pointer operation is made. Likewise, a right pointing command is transmitted when a rightward pointer operation is made, a down pointing command is transmitted when a downward pointer operation is made, and an up pointing command is transmitted when an upward pointer operation is made.

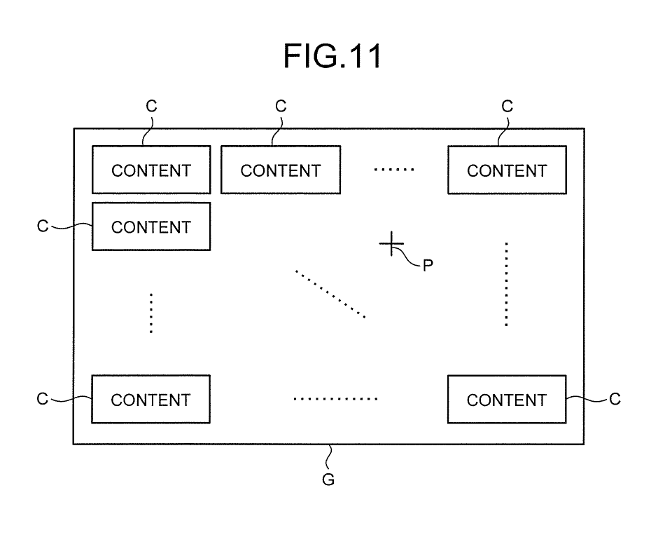

Now, the display of the display device 200 in accordance with the pointing commands and the scroll commands will be described. FIG. 11 is a schematic diagram for explaining an example of a screen G.

As illustrated in FIG. 11, the screen G is displayed on the display surface 201 of the display device 200, and is an example of a screen that has a plurality of items of content C arranged in a tiled manner and receives the selection of an item of the content C by a pointer P. The items of the content C not fitted into the screen G are included in a separate display page, and thus only the items of the content C for one display page that fit into the screen G are displayed. On the screen G, the user operates the touch pad 103 of the apparatus operation device 100 and points the pointer P at a desired item of the content C. This enables the user to select the item of the content C in the display page displayed on the screen G.

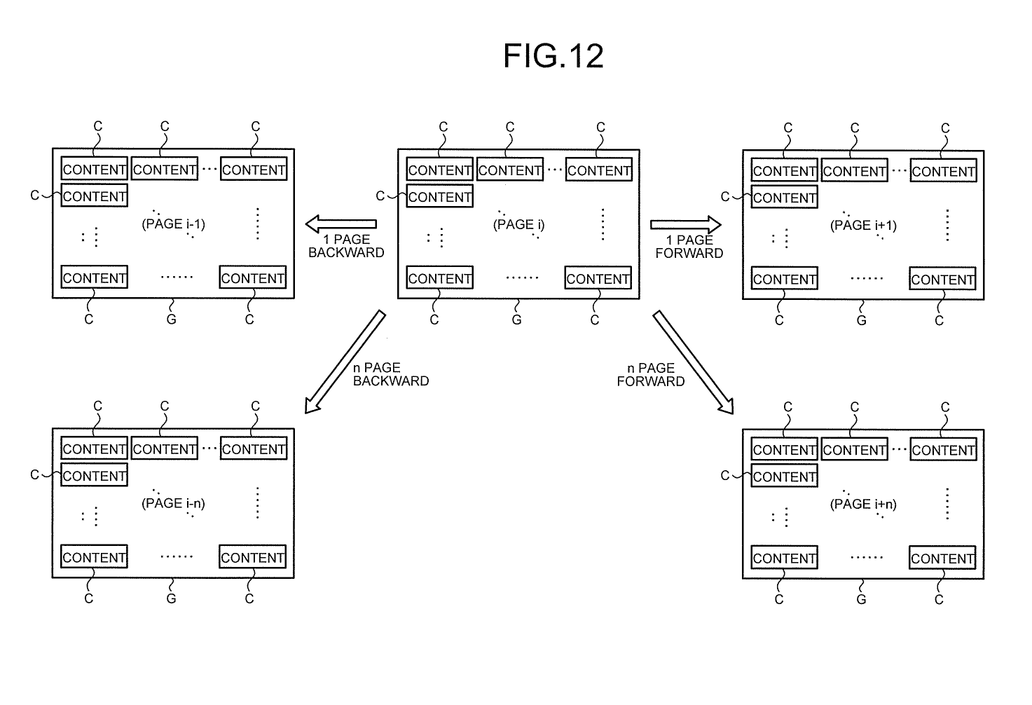

FIG. 12 is a schematic diagram for explaining an example of changes of the screen G. As illustrated in FIG. 12, when a desired item of the content C is not found in the displayed page (page i) currently displayed, the user searches the content in other display pages. When changing the display page to the other display pages, the user swings the apparatus operation device 100 in a direction to move the display page forward or backward to output a scroll command to the display device 200 so as to change the display page.

More specifically, the display device 200 changes the screen G to a display page one page backward (page i−1) from the display page (page i) based on a left scroll command by a one-time leftward swing motion. Likewise, the display device 200 changes the screen G to a display page one page forward (page i+1) from the display page (page i) based on a right scroll command by a one-time rightward swing motion. Meanwhile, when the scroll command has the amount of scroll set up, the display device 200 may change the screen G to a display page a number of pages (n pages) backward (or forward) corresponding to the amount of scroll.

As in the foregoing, the user makes an intuitive operation such as the selection of an item of the content C in the display page by a pointer operation on the touch pad 103 and the change of display pages by a swing motion of the apparatus operation device 100, whereby the user is allowed to easily select a desired item of the content C out of a number of items of the content C.

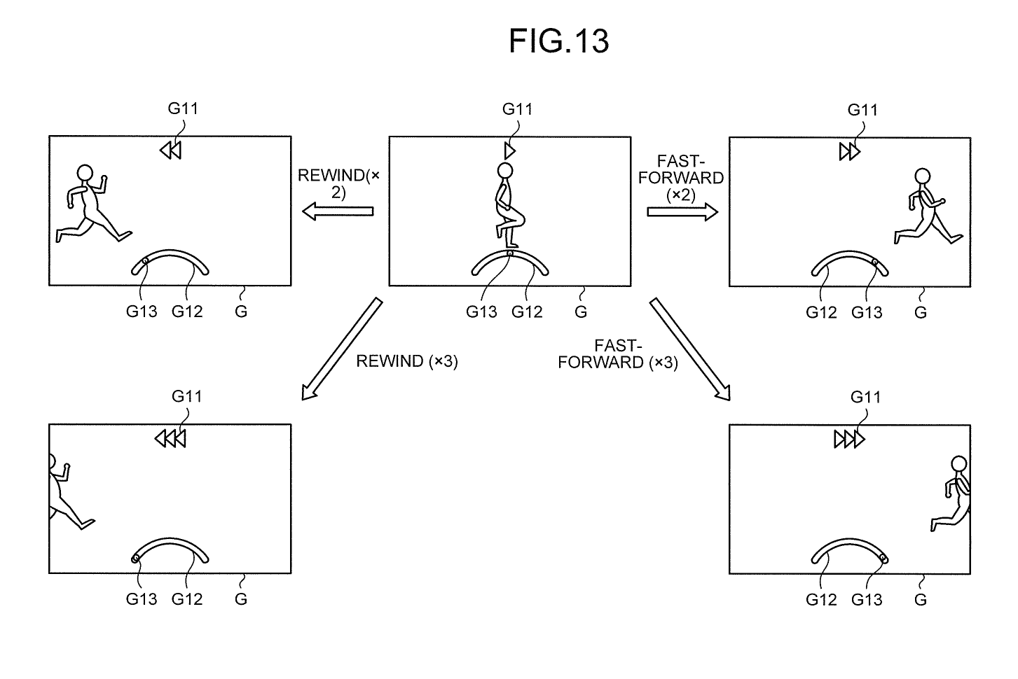

The change of the screen G by a scroll command is not restricted to the change of display pages, and may be a change of reproduction speed of the content in reproduction. FIG. 13 is a schematic diagram for explaining an example of changes of the screen G, illustrating an example of the change of reproduction speed of the content in reproduction.

As illustrated in FIG. 13, the screen G in reproduction of the content displays a reproduction status display G11 indicating a status of reproduction such as reproduction, rewind (×2), rewind (×3), fast-forward (×2), and fast-forward (×3), and a slider bar G12 and a slider G13 concerning the operation of reproduction speed. The slider bar G12 is in an arc form having a portion projected towards the upper side of the screen. When the slider G13 is positioned at the center of the slider bar G12, a normal reproduction is made. When the slider G13 is moved towards the right side from the center, a reproduction in fast-forward is made, and when the slider G13 is moved towards the left side from the center, a reproduction in rewind is made. While the content is reproduced, the user thus tilts the apparatus operation device 100 in a direction to change the reproduction speed forward or backward to output a scroll command to the display device 200 so as to change the reproduction speed.

More specifically, the display device 200 changes the screen G from the normal reproduction to the rewind (×2) based on a left scroll command corresponding to a leftward tilt that means the X axis (X direction) acceleration is equal to or greater than the threshold X1. Likewise, the display device 200 changes the screen G from the normal reproduction to the fast-forward (×2) based on a right scroll command corresponding to a rightward tilt meaning the X axis (X direction) acceleration being equal to or greater than the threshold X2. When the scroll commands have the amount of scroll set up based on thresholds defined in steps in the positive and negative directions of the X axis, the screen G may be changed to the reproduction speed (such as ×3) corresponding to the amount of scroll set up. As in the foregoing, the user makes an intuitive operation such as a tilting motion of the apparatus operation device 100, whereby the user is allowed to set the reproduction speed of the content in reproduction. When the motion input module 101 comprises an angular velocity sensor or an orientation sensor that detects orientation of the apparatus operation device 100, the apparatus operation device 100 determines a tilt in response to the orientation detected and outputs a command corresponding to the orientation. In this case, the apparatus operation device 100 may output a left or right scroll command when the apparatus operation device 100 is rotated by a predetermined threshold or greater in the counter-clockwise or clockwise direction around the Z axis in FIG. 2, or may output a left or right scroll command when the apparatus operation device 100 is rotated by a predetermined threshold or greater in the counter-clockwise or clockwise direction around the Y axis.

### Second Embodiment

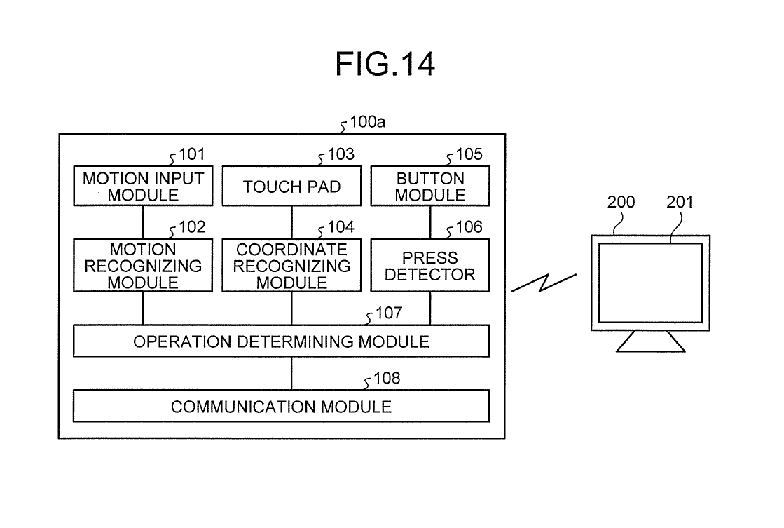

A second embodiment will be described. FIG. 14 is a block diagram illustrating the functional configuration of an apparatus operation device 100a according to the second embodiment. As illustrated in FIG. 14, the apparatus operation device 100a comprises, other than those in the functional configuration illustrated in the above-described first embodiment, a button module 105 and a press detector 106 in addition.

The button module 105 is a button switch or the like that receives a press operation of the user. More specifically, the button module 105 is disposed underneath the touch pad 103 and may be configured to be pressed (clicked) by pressing the whole touch pad 103 with a finger. The press detector 106 detects the press operation made in the button module 105 based on a signal in response to the press in the button module 105.

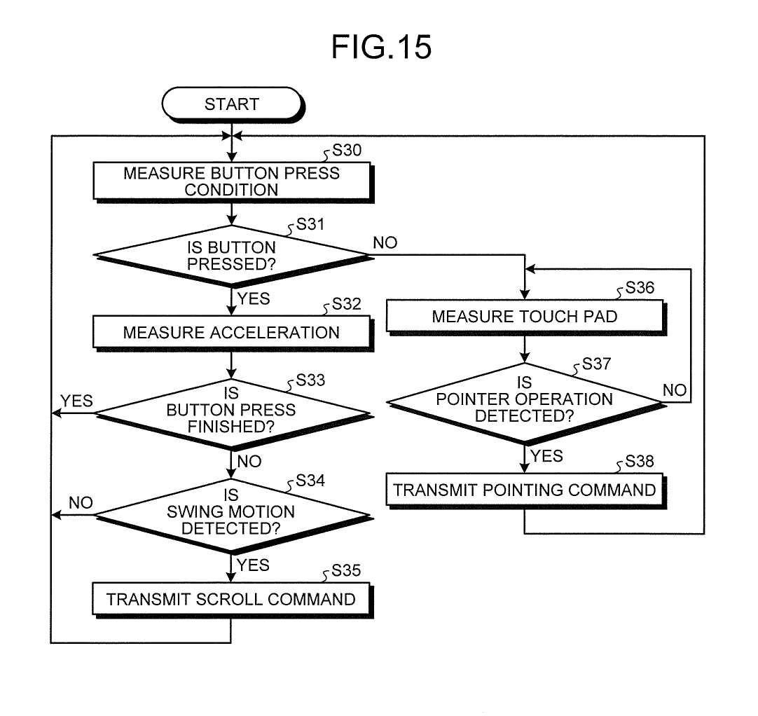

Next, the process to transmit a scroll command and a pointing command will be described more specifically. FIG. 15 is a flowchart illustrating an example of operation of the apparatus operation device 100a in the second embodiment.

As illustrated in FIG. 15, once the process is started, the button module 105 measures a condition of press (S30). The press detector 106 then determines whether the button is pressed based on the signal from the button module 105 (S31).

When a button press in the button module 105 is determined (Yes at S31), the motion input module 101 measures the acceleration of the apparatus operation device (S32). The press detector 106 then determines whether the button press is finished based on the signal from the button module 105 (S33). When the button press is finished (Yes at S33), the operation determining module 107 returns to the process at S30.

When the button press is not finished (No at S33), the operation determining module 107 then determines whether the motion recognizing module 102 detected a predetermined swing motion based on the acceleration measured by the motion input module 101 (S34). More specifically, the apparatus operation device 100a recognizes the swing motion made while the button in the button module 105 is pressed.

When a swing motion in the up-down or left-right direction is recognized (Yes at S34), the operation determining module 107 transmits a scroll command corresponding to the swing motion in the up-down or left-right direction recognized to the display device 200 via the communication module 108 (S35).

When the button press in the button module 105 is not recognized (No at S31), the touch pad 103 measures a pointer operation on the touch pad (S36). The operation determining module 107 then determines whether a pointing operation is detected based on the measurement of the touch pad 103 (S37). When no pointer operation is detected (No at S37), the operation determining module 107 returns to the process at S36. When a pointer operation is detected, the operation determining module 107 transmits a pointing command corresponding to the pointer operation to the display device 200 via the communication module 108 (S38).

As in the foregoing, the apparatus operation device 100a recognizes a swing motion made while the button in the button module 105 is pressed and outputs a scroll command corresponding to the swing motion to the display device 200, and thus false recognition of swing motion not intended by the user can be prevented.

### Third Embodiment

A third embodiment will be described. The third embodiment differs from the first embodiment in terms of that the swing motion of the apparatus operation device 100 recognized as a motion other than the target motions (S15) in the first embodiment is regarded as a pointer operation (of a large movement) and the operation in the touch pad 103 is regarded as a pointer operation (of a small movement). The functional configuration in the third embodiment is nearly the same as that of the apparatus operation device 100 in the first embodiment.

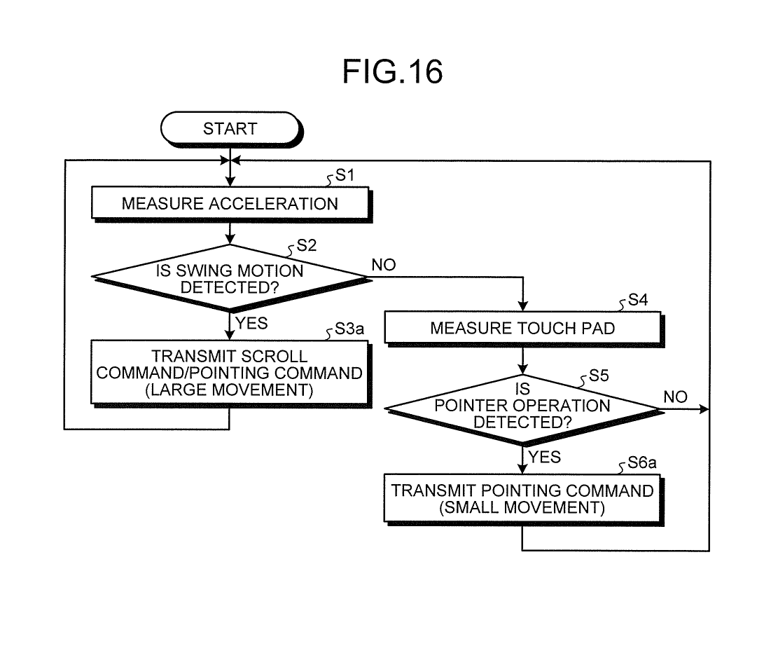

FIG. 16 is a flowchart illustrating an example of operation of the apparatus operation device 100 in the third embodiment. As illustrated in FIG. 16, when a swing motion in the up-down or left-right direction is recognized (Yes at S2), the operation determining module 107 transmits a scroll command corresponding to the swing motion in the up-down or left-right direction recognized to the display device 200 via the communication module 108 (S3a). When the motion is a tilting motion in the up-down or left-right direction at S3a, the operation determining module 107 transmits a pointing command (of a large movement) corresponding to the direction of the tilt to the display device 200 via the communication module 108.

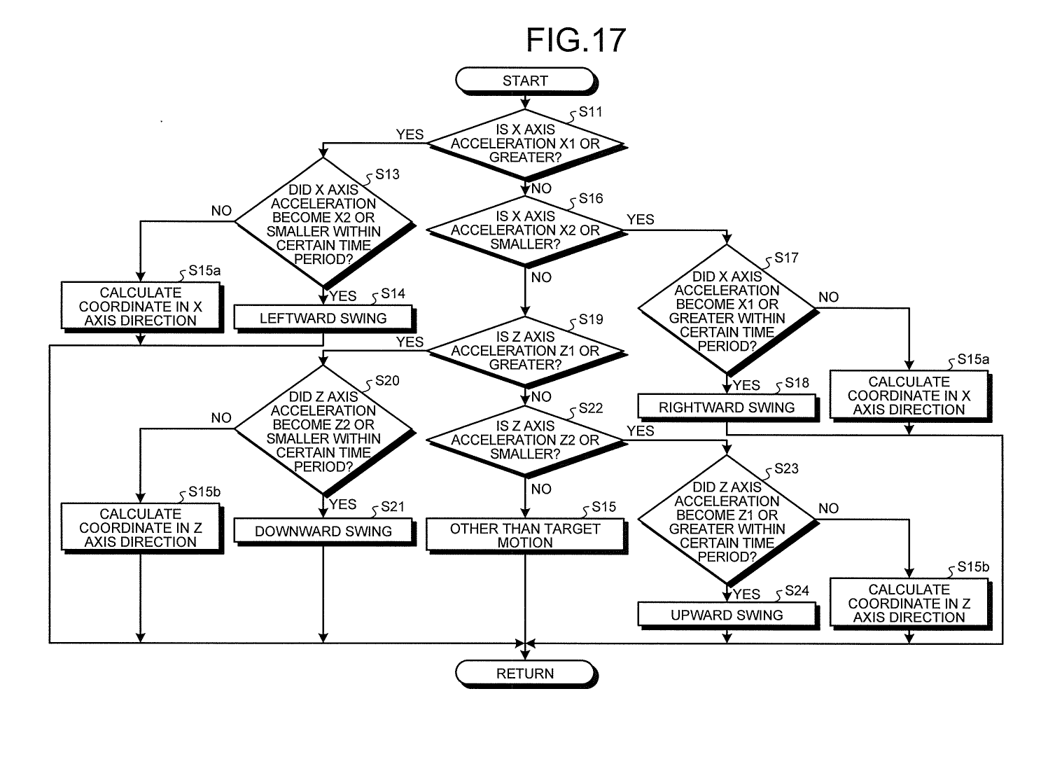

FIG. 17 is a flowchart illustrating an example of a process to detect a swing motion in the third embodiment.

As illustrated in FIG. 17, when a small swing motion in a left direction not detected as a leftward swing motion is made (No at S13), the motion recognizing module 102 calculates a coordinate in the X axis direction based on the amount of tilt (S15a). More specifically, the motion recognizing module 102 recognizes a pointer operation in the left direction. Likewise, when a small swing motion in a right direction not detected as a rightward swing is made (No at S17), the motion recognizing module 102 calculates a coordinate in the X axis direction (S15a) to recognize a pointer operation in the right direction.

Furthermore, when a small swing motion in a downward direction not detected as a downward swing motion is made (No at S20), the motion recognizing module 102 calculates a coordinate in the Z axis direction based on the amount of tilt (S15b). More specifically, the motion recognizing module 102 recognizes a pointer operation in the downward direction. When a small swing motion in an upward direction not detected as an upward swing motion is made (No at S23), the motion recognizing module 102 similarly calculates a coordinate in the Z axis direction (S15b) to recognize a pointer operation in the upward direction.

Referring back to FIG. 16, when a pointer operation is detected (Yes at S5), the operation determining module 107 transmits a pointing command (of a small movement) corresponding to the pointer operation to the display device 200 via the communication module 108 (S6a).

As in the foregoing, the third embodiment allows the pointer P on the screen G to be moved largely by the direction of tilt of the apparatus operation device 100 and allows the pointer P on the screen G to be moved finely by the operating instructions of the touch pad 103. The combination of an intuitive operation by the swing motion of the apparatus operation device 100 and a minute operation on the touch pad 103 in the third embodiment thus allows the operability of the pointer P on the screen G to be further improved. Consequently, for example, the user can easily select a desired item of the content C out of a number of items of the content C on the screen G.

The program executed by the apparatus operation devices 100 and 100a in the first to the third embodiments is provided in a ROM and such being embedded in advance. The program executed by the apparatus operation devices 100 and 100a in the embodiments may be provided in a file of an installable format or an executable format recorded on a computer readable recording medium such as a compact disc read-only memory (CD-ROM), a flexible disk (FD), a compact disc-recordable (CD-R), and a digital versatile disk (DVD).

Furthermore, the program executed by the apparatus operation devices 100 and 100a in the first to the third embodiments may be stored on a computer connected to a network such as the Internet to be provided by downloading the program via the network. The program executed by the apparatus operation devices 100 and 100a in the first to the third embodiments may be provided or distributed via a network such as the Internet.

The program executed by the apparatus operation devices 100 and 100a in the first to the third embodiments is modularly configured to comprise the above-described functional modules. In regard to the actual hardware, a CPU (processor) reads out the program from the ROM and executes the program to load and generate each of the functional modules on a main storage device.

While the apparatus operation device 100 illustrated and described in the first to the third embodiments comprises the operation determining module 107, the operation determining module 107 may be provided outside the apparatus operation device 100. More specifically, when an external module comprises the operation determining module 107, the apparatus operation device 100 may output parameters output from the motion recognizing module 102, the coordinate recognizing module 104, the press detector 106, and others to the external module via the communication module 108, and the external module may generate a command corresponding to the parameters received and then output the command to the display device 200. The external module may further be built in the display device 200.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An apparatus operation device comprising:
a direction operation module configured to receive an operating instruction in a two-dimensional direction;
a recognizing module configured to recognize a swing motion or a tilting motion of the apparatus operation device; and
an output module configured to output a first operation command corresponding to a first operation for screen transition corresponding to a predetermined condition when the swing motion or the tilting motion recognized satisfies the predetermined condition, and to output a second operation command corresponding to a second operation for transition of a pointer on the screen in the two-dimensional direction when the operating instruction in the two-dimensional direction is received.

2. The apparatus operation device of claim 1, wherein
the recognizing module is configured to recognize a swing motion in one direction in which the apparatus operation device is swung and swung back or is tilted and tilted back in the one direction, and
the output module is configured to output the first operation command for the screen transition in a direction corresponding to the swing motion.

3. The apparatus operation device of claim 1, wherein
the recognizing module is configured to recognize a degree of swing or a degree of tilt of the apparatus operation device, and
the output module is configured to output the first operation command corresponding to the first operation and for the screen transition by an amount based on the degree of swing or the degree of tilt recognized.

4. The apparatus operation device of claim 1, wherein the screen transition is transition of a display page displayed on the screen or transition of reproduction speed of content reproduced on the screen.

5. The apparatus operation device of claim 1, further comprising:
a press operation module configured to receive a press operation, wherein
the recognizing module is configured to recognize the swing motion or the tilting motion while the press operation is received.

6. An apparatus operation device comprising:
a direction operation module configured to receive an operating instruction in a two-dimensional direction;
a recognizing module configured to recognize a swing motion or a tilting motion of the apparatus operation device; and
an output module configured to output a first operation command corresponding to a first operation for transition of a pointer on a screen by a first movement in a direction corresponding to a predetermined condition when the swing motion or the tilting motion recognized satisfies the predetermined condition, and to output a second operation command corresponding to a second operation for transition of the pointer on the screen by a second movement smaller than the first movement in the two-dimensional direction when the operating instruction in the two-dimensional direction is received.

7. A computer program product having a non-transitory computer readable medium including programmed instructions, wherein the instructions, when executed by a computer, cause the computer to perform:
receiving an operating instruction in a two-dimensional direction;
recognizing a swing motion or a tilting motion of an apparatus operation device; and
outputting a first operation command corresponding to a first operation for screen transition corresponding to a predetermined condition when the swing motion or the tilting motion recognized satisfies the predetermined condition, and to output a second operation command corresponding to a second operation for transition of a pointer on the screen in the two-dimensional direction when the operating instruction in the two-dimensional direction is received.
